(19) United States
(12) Patent Application Publication
(10) Pub. No.: US 2010/0191448 A1
(43) Pub. Date: Jul. 29, 2010

(54) OPERATING METHOD FOR AN INTERNAL COMBUSTION ENGINE AND ASSOCIATED MOTOR VEHICLE

(75) Inventors: Juergen Hofmann, Korntal-Muenchingen (DE); Oliver Froelich, Bietigheim-Bissingen (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/696,432

(22) Filed: Jan. 29, 2010

(30) Foreign Application Priority Data
Jan. 29, 2009 (DE) 10 2009 006 666.7

(51) Int. Cl. G06F 19/00

(52) U.S. Cl. 701/113

(57) ABSTRACT

A method for operating an internal combustion engine in a motor vehicle, in which the internal combustion engine is switched off automatically as soon as it is not required, and in which the internal combustion engine is started automatically as soon as it is required or as soon as a timeout has expired. In order to increase the service life of the battery, the timeout is changed in dependence on a characteristic value which is correlated with the capacity of the battery.

### CROSS-REFERENCE TO RELATED APPLICATION

This application claims the priority, under 35 U.S.C. §119, of German application DE 10 2009 006 666.7, filed Jan. 29, 2009; the prior application is herewith incorporated by reference in its entirety.

### BACKGROUND OF THE INVENTION

### Field of the Invention

The present invention relates to a method for operating an internal combustion engine in a motor vehicle. The invention also relates to a motor vehicle.

In order to reduce the fuel consumption of a motor vehicle, it is known to operate the internal combustion engine in what is referred to as a start/stop mode in which the internal combustion engine is switched off automatically as soon as it is no longer required, and in which the internal combustion engine is started again automatically as soon as it is required again. If the internal combustion engine is switched off, the electrical loads of the vehicle are supplied with power by a battery. When the internal combustion engine is switched on, the battery can be charged again by a corresponding generator, referred to as a dynamo. In order to avoid excessive discharging of the vehicle battery when the internal combustion engine is switched off, the deactivation of the internal combustion engine can be limited to a maximum predetermined timeout. Once this timeout has expired, the internal combustion engine is started again, irrespective of whether it is actually required. The internal combustion engine is not required, for example, when the vehicle is braked or when the vehicle is travelling downhill or when the vehicle is stationary, for example at a traffic light. In particular, the internal combustion engine is not required whenever the vehicle does not need drive power. Conversely, the internal combustion engine is preferably required when the vehicle requires drive power for its propulsion. However, other criteria for the need for the internal combustion engine to be switched on are also conceivable. For example, an air conditioning system generally requires more current than the vehicle battery can make available. Switching on the air conditioning system can therefore also make it necessary to switch on the internal combustion engine.

Conventional vehicle batteries, referred to as accumulators, in particular lead accumulators, are subject to wear. Their capacity decreases over time. For example, the capacity of the battery decreases with its energy throughput, with the result that, for example, the number of charge cycles which can be executed is limited. In addition, the individual components of the battery age. This ageing is also referred to as the state of health and occasionally abbreviated to SoH. This state of health decreases during the course of the operation of the battery until the battery is so weak that it is no longer sufficient to start the internal combustion engine.

In the start/stop mode mentioned above, the battery is loaded very heavily, as a result of which it ages comparatively quickly and has a comparatively short service life.

### SUMMARY OF THE INVENTION

It is accordingly an object of the invention to provide an operating method for an internal combustion engine and associated motor vehicle which overcome the above-mentioned disadvantages of the prior art methods and devices of this general type, which is defined in particular by the fact that the respective battery has an increased service life.

With the foregoing and other objects in view there is provided, in accordance with the invention a method for operating an internal combustion engine in a motor vehicle. The method includes the steps of: switching off automatically the internal combustion engine as soon as it is not required; starting automatically the internal combustion engine one of as soon as it is required and as soon as a timeout has expired; and changing the timeout in dependence on a characteristic value correlated with a capacity of a battery for supplying power to an on-board electrical system.

The invention is based on the general idea that the timeout, after the expiry of which the internal combustion engine is started again even if it is not at all required, is changed in dependence on a characteristic value which is correlated with the capacity of the battery. In other words, the timeout is variable and is selected as a function of the current capacity of the battery. Appropriately adapting the timeout to the actual capacity of the battery permits the loading of the battery to be reduced, as a result of which it has a longer service life. Suitable adaptation of the timeout to the current capacity of the battery permits the great advantage of the start/stop mode also to be used for the majority of events which lead to the internal combustion engine being switched off. In particular, the overrun mode of the vehicle lasts for a relatively long time comparatively rarely, with the result that in this respect shortened timeouts also provide the desired saving in fuel. Most stationary times are also comparatively short, in the stop and go traffic mode, for example, with the result that there is also no adverse effect on the start/stop mode here. Only relatively long waiting times at traffic lights or railway crossings can bring about premature restarting of the internal combustion engine when there is a shortened timeout. However, these cases are rare compared to the others, with the result that overall the saving of fuel by the start/stop mode is largely maintained even in the case of relatively short timeouts.

The timeout is advantageously adapted as a function of the specified characteristic value in such a way that the timeout is shortened as the capacity of the battery decreases. Consequently, the internal combustion engine is restarted earlier. This leads to a situation in which the power output of the battery is reduced during the timeout, which decreases the loading on the battery.

An embodiment in which the timeout has a predetermined maximum value as long as the characteristic value is in a value range which correlates with a high capacity of the battery is particularly advantageous. In other words, as long as the capacity of the battery is in an upper range, the timeout is constant, and is specifically limited to a predetermined maximum. This maximum timeout can be formed by an optimum value which represents an optimum, for example in terms of fuel consumption, emission values, component wear and driving comfort, in the start/stop mode. Therefore, as long as the battery has a sufficiently high capacity, the timeout is constant and exhibits its maximum value.

In another embodiment, which can be implemented in addition to that above, the timeout can have the value zero, as soon as the characteristic value is in a value range which correlates with a low capacity of the battery. In other words, the start/stop mode is deactivated in a low capacity range. The internal combustion engine is no longer switched off if it is no longer required. In the range of such low capacity, the continuation of the start/stop mode would cause the battery to age within a very short time to such an extent that it would no longer be possible to ensure restarting of the internal combustion engine. In order to reduce the loading on the vehicle battery and to ensure that the vehicle can still travel under its own power to a workshop or to a place where its battery can be replaced, the fuel-efficient start/stop mode is temporarily dispensed with.

In another embodiment, which can also be implemented in addition to at least one of the embodiments above, the timeout can be reduced, in dependence on the characteristic value, from a predetermined maximum to a predetermined minimum which is above the value zero, as long as the characteristic value is in a value range which correlates with a medium capacity of the battery. The actual adaptation of the timeout to the capacity of the battery takes place in this mode. This range of the medium capacity can be extended chronologically for a comparatively long time through adept selection of the timeout, and this directly extends the service life of the battery.

A linear adaptation of the timeout to the characteristic value is conceivable, for example. Likewise, stepped adaptation is conceivable.

Of course, the features mentioned above and the features to be explained below can be used not only in the respectively specified combination but also in other combinations or alone, without departing from the scope of the present invention.

Other features which are considered as characteristic for the invention are set forth in the appended claims.

Although the invention is illustrated and described herein as embodied in an operating method for an internal combustion engine and associated motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a highly simplified, diagram of a motor vehicle; and

FIG. 2 is a diagram illustrating an operating method according to the invention.

### DETAILED DESCRIPTION OF THE INVENTION

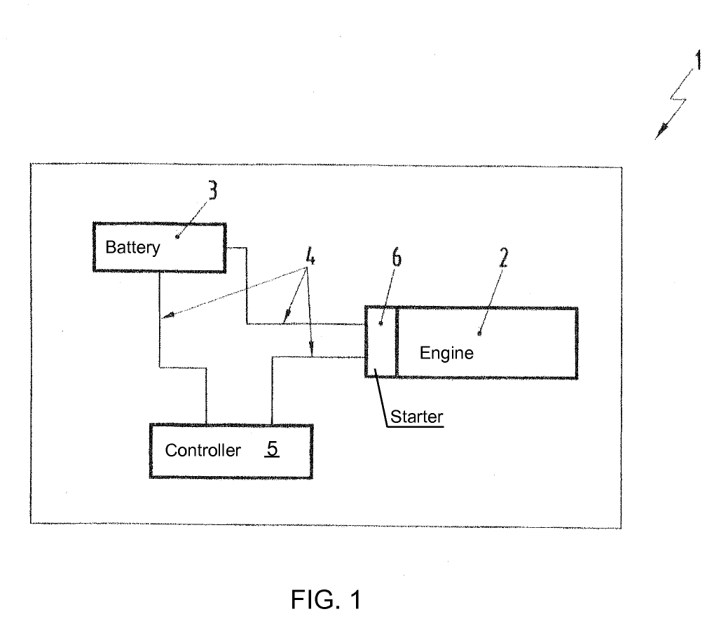

In the drawings identical reference symbols relate to identical or similar or functionally identical components. Referring now to the figures of the drawing in detail and first, particularly, to FIG. 1 thereof, there is shown a motor vehicle 1 that contains an internal combustion engine 2, a battery 3 for supplying power to an on-board electrical system 4 and a controller 5. A starter 6 is provided for starting the internal combustion engine 2. The starter 6 can simultaneously also be used as a generator and configured, in particular, as a starter generator. The controller 5 is used to operate the internal combustion engine 2. It is configured, in particular, in such a way that it can carry out a start/stop mode for operating the internal combustion engine 2. If the vehicle 1 or the internal combustion engine 2 is operated in the start/stop mode, the controller 5 switches off the internal combustion engine 2 automatically as soon as the internal combustion engine 2 is not required. For example, the vehicle 1 is then in an overrun mode or in a stationary mode. The controller 5 switches the internal combustion engine 2 on again as soon as it is required again, for example if the vehicle 1 requires drive power or if a large electrical load of the on-board power system 4 is switched on and the power requirement cannot be covered by the battery 3. The controller 5 starts the internal combustion engine 2 as soon as a timeout T has expired, even when the internal combustion engine 2 is not required per se. The definition of such a timeout T, which starts the internal combustion engine 2 again despite it not being required, prevents excessive loading of the battery 3 and leads to charging or recharging of the battery 3 by the starter generator 6 while the internal combustion engine 2 is operating.

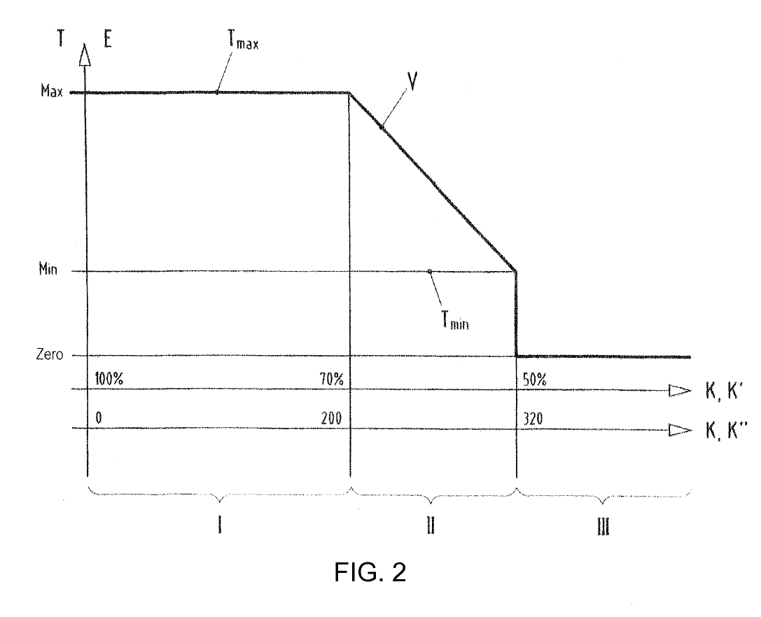

The controller 5 can be configured or programmed in such a way that it can carry out the method for operating the internal combustion engine 2 in the vehicle 1 which is also explained in more detail below with reference to FIG. 2.

Within the scope of this operating method, the previously mentioned timeout T is changed as a function of a characteristic value K. The characteristic value K correlates here with the capacity of the battery 3. In the diagram in FIG. 2, a profile V is represented which represents, on the one hand, the timeout T as a function of the characteristic value K. On the other hand, the profile V also represents the energy output E of the battery 3 during the respective timeout T if it can be completely utilized. The timeout T and the energy output E have a maximum Max and a minimum Min and can also assume the value zero. Two different examples, which can also be referred to below by K′ and K″, are represented for the characteristic value K in FIG. 2.

In the diagram in FIG. 2 the capacity of the battery decreases from left to right along the abscissa. The battery 3 exhibits its maximum capacity directly on the ordinate. The capacity decreases as the distance from the ordinate increases. This can correlate with an increase or decrease in the respective characteristic value K. The controller 5 therefore changes the timeout T as a function of the capacity of the battery 3, that is to say as a function of the characteristic value K. The controller 5 preferably shortens the timeout T as the capacity of the battery 3 decreases.

Three phases I, II and III are clearly denoted in the diagram in FIG. 2 by use of curly brackets. In a first phase I, the timeout T has a predetermined maximum Tₘₐₓ, specifically the maximum Max which is characterized on the ordinate. The timeout T has this maximum Tₘₐₓ as long as the characteristic value K is in a value range which correlates with a high level of capacity of the battery 3. During the first phase I, the battery 3 can be loaded electrically to maximum degree during the respective stop time of the internal combustion engine 2, and in this context this electrical loading can also be limited to the timeout T and therefore to its maximum Tₘₐₓ. For example, the maximum Tₘₐₓ of the timeout T can be in a range from inclusive 2 minutes to inclusive 4 minutes. As a result of this maximum Tₘₐₓ, for example up to 80% of all stopping processes or deactivation processes of the internal combustion engine 2 can be covered within the scope of the start/stop mode.

In a second Phase II, the timeout T can decrease from the maximum Tₘₐₓ as far as a predetermined minimum Tₘᵢₙ as a function of the respective characteristic value K, in which case this minimum timeout Tₘᵢₙ is above the value zero. This decrease from the maximum Tₘₐₓ to the minimum Tₘᵢₙ takes place for as long as the characteristic value K is in a value range which correlates with an average capacity of the battery 3. FIG. 2 shows a linear relationship between the characteristic value K and the timeout T. It is clear that basically a progressive or degressive relationship can also be implemented. Likewise, a stepped reduction in the timeout T from the maximum Tₘₐₓ as far as the minimum Tₘᵢₙ is conceivable. The minimum Tₘᵢₙ of the timeout T can be in a range from inclusive 0.5 minutes to inclusive 1 minute. The minimum Tₘᵢₙ can therefore be in a range from inclusive 12.5% to inclusive 25% of the maximum Tₘₐₓ. In accordance with the reduced timeout T, the battery 3 can only then output reduced energy, as a result of which the loading on the battery 3 is reduced.

A third Phase III is characterized in that the timeout T assumes the value zero. This is the case when the characteristic value K is in a value range which correlates with a low capacity of the battery 3. With respect to the operating method, this means that the start/stop mode is deactivated in the third Phase III. The internal combustion engine 2 is no longer switched off automatically by the controller 5 when, for example, no drive power is required any more, that is to say when the internal combustion engine 2 per se is not required. As a result, the battery 3 cannot be loaded any longer either. The weakened battery 3 is then still required only for the initial starting or cold starting of the internal combustion engine 2. This then corresponds to a conventional permanent operating mode of the internal combustion engine 2.

For example a power-related state of health or state of ageing of the battery, which can also be referred to as ToHp, can be used as the characteristic value K. This power characteristic value K′ is additionally represented in the diagram in FIG. 2 and represents a reference variable which compares the existing actual power of the battery 3 with a set point power of a new battery 3. The capacity of the battery 3 is in an upper or high range if its capacity is, with respect to a new battery, in a range from inclusive 100% to inclusive 70%. A medium capacity of the battery 3 is present, for example, when the power characteristic value K′ is in a range from 70% to 50%, again related to a new battery. Any lower or low capacity of the battery 3 is present when the power characteristic value K′ is again in a range from inclusive 50% to inclusive 0% with respect to a new battery. Given such exemplary classification, a value of at least 70% is obtained for the power characteristic value K′ if the battery 3 has a high capacity. The characteristic value K′ is between 70% and 50% if the battery 3 has a medium capacity. If the battery 3 still only has a low capacity, a value of 50% at maximum is obtained for the characteristic value K′.

The ageing or the state of health can be determined by the controller 5, for example by measuring the internal resistance of the battery 3.

The controller 5 can additionally or alternatively also monitor the capacity of the battery 3 by reference to the energy throughput. An energy throughput of the battery 3 can therefore be used as the characteristic value K″. The associated energy characteristic value K″ is additionally entered in the diagram in FIG. 2. The energy throughput of the battery 3 can be referred to full charge cycles, referred to as full cycles. The service life of the battery 3 is limited to a maximum number of full cycles, which can be determined empirically. To this extent, the energy throughput also correlates to the capacity of the battery 3. For example, the battery 3 has up to 200 full cycles as its upper capacity. Between 200 and 320 full cycles, the battery 3 exhibits, for example, its medium capacity. From 320 full cycles, it can be assumed, for example, that the battery 3 still only has its lower capacity. For example, the capacity of the battery 3 ends at about 400 full cycles. For the individual phases this means that in the first phase I the energy characteristic value K″ exhibits at maximum a value of 200 full cycles, with the result that the battery 3 has its high capacity. In the second phase II, the battery 3 has its medium capacity with the result that the energy characteristic value K″ is between 200 and 320 full cycles. The third phase III is present when the energy characteristic value K″ indicates more than 320 full cycles, with the result that the battery 3 then exhibits its low capacity.

In particular in the case of the energy throughput, the controller 5 can operate with a counter in order to add the number of deactivation processes or, if appropriate, the individual timeouts T or any desired characteristic variable correlated with the capacity of the battery 3. When the battery is changed, the controller 5 can, for example, be connected to a diagnostic device which can then be used to reset the respective counter. If a battery change is carried out without such a diagnostic device, malfunctions may occur. In one particular embodiment, the controller 5 can be configured in such a way that when the internal combustion engine 2 starts, specifically in particular in the case of initial starting or cold starting, it is checked whether the battery 3 has been replaced with a new battery. This can be detected, for example, by virtue of the fact that suddenly a higher voltage is present at the battery 3 than when it was last activated. Likewise, other battery parameters 3 may also change, for example its internal resistance, if it is replaced with a new one. The control device 5 can automatically reset the respective counter if it detects the presence of a new battery 3. In order to avoid erroneous resetting of the respective counter, the controller 5 can increment an associated counter if it detects a new battery 3. As soon as a new battery 3 is detected, for example, five to ten times in succession, the controller 5 assumes that a new battery 3 is actually present and only then does it reset the counter which is relevant for the capacity of the battery 3.

The numerical examples given in the description above are to be understood as merely exemplary and without restriction on the generality unless they have occurred in the independent claims.

1. A method for operating an internal combustion engine in a motor vehicle, which comprises the steps of:
switching off automatically the internal combustion engine as soon as it is not required;
starting automatically the internal combustion engine one of as soon as it is required and as soon as a timeout has expired; and
changing the timeout in dependence on a characteristic value correlated with a capacity of a battery for supplying power to an on-board electrical system.

2. The method according to claim 1, which further comprises changing the timeout in dependence on the characteristic value such that the timeout is shortened as the capacity of the battery decreases.

3. The method according to claim 1, which further comprises providing the timeout with a predetermined maximum as long as the characteristic value is in a value range which correlates with a high capacity.

4. The method according to claim 1, which further comprises setting the timeout to have a value of zero as soon as the characteristic value is in a value range which correlates with a low capacity.

5. The method according to claim 1, which further comprises reducing the timeout, in dependence on the characteristic value, from a predetermined maximum to a predetermined minimum which is above a value zero, as long as the characteristic value is in a value range which correlates with a medium capacity.

6. The method according to claim 5, which further comprises reducing the timeout linearly from the predetermined maximum to the predetermined minimum in dependence on the characteristic value.

7. The method according to claim 5, which further comprises reducing the timeout in a plurality of stages from the predetermined maximum to the predetermined minimum dependence on the characteristic value.

8. The method according to claim 5, which further comprises setting the predetermined minimum to be in a range from inclusive 12.5% to inclusive 25% of the predetermined maximum.

9. The method according to claim 1, which further comprises using one of a power-related state of health and a state of ageing of the battery as the characteristic value.

10. The method according to claim 9, wherein the power-related state of health or the state of ageing of the battery produces, with respect to a new battery, the characteristic value of at least 70% if the battery has a high capacity, produces a characteristic value between 70% and 50% if the battery has a medium capacity, and produces a characteristic value of 50% at maximum if the battery has a low capacity.

11. The method according to claim 1, which further comprises designating an energy throughput rate of the battery as the characteristic value.

12. The method according to claim 11, wherein the energy throughput rate of the battery with respect to full charge cycles exhibits the characteristic value of 200 full cycles at maximum if the battery has a high capacity, exhibits the characteristic value between 200 and 320 full cycles if the battery has a medium capacity, and exhibits the characteristic value of at least 320 full cycles if the battery has a low capacity.

13. The method according to claim 1, which further comprises that when the internal combustion engine is started, checking whether the battery has been replaced with a new battery for resetting a counter for a characteristic variable which is correlated with the capacity of the battery.

14. A motor vehicle, comprising:
an internal combustion engine;
an on-board electrical system;
a battery; and
a controller programmed to:
switch off automatically said internal combustion engine as soon as it is not required;
start automatically said internal combustion engine one of as soon as it is required and as soon as a timeout has expired; and
change the timeout in dependence on a characteristic value correlated width a capacity of said battery for supplying power to said on-board electrical system.
